(19) United States
(12) Patent Application Publication
(10) Pub. No.: US 2025/0364869 A1
(43) Pub. Date: Nov. 27, 2025

(54) CO-AXIAL LAYSHAFT GEAR TRAIN BRACKET

(71) Applicant: Dana Automotive Systems Group, LLC, Maumee, OH (US)

(72) Inventors: Cody OTT, Ida, MI (US); Gowrisankar DEVARAJ, Leamington Spa (GB)

(21) Appl. No.: 18/671,724

(22) Filed: May 22, 2024

(51) Int. Cl. H02K 7/116

(52) U.S. Cl. CPC H02K 7/116

(57) ABSTRACT

Systems are provided for a support for a gear train. For an example, a system, comprising: an electric motor comprising an electric motor output shaft; a gear train comprising an input gear coupled to a first gear arranged on a lay shaft, further comprising a second gear arranged on the lay shaft and coupled to an output gear, wherein the input gear is further coupled to the electric motor output shaft and the output gear is coupled to a gear train output shaft; and a support physically coupled to a housing of the electric motor, wherein the support is configured to support a bearing coupled to the output gear.

### TECHNICAL FIELD

The present description relates to a bracket mounted to a housing of an electric machine and supports an output gear of a gear train to be co-axial with an input gear of the gear train.

### BACKGROUND AND SUMMARY

Vehicles may include a gear train to modify a torque output of a mover to meet a driver demand. Some vehicle gear trains may include a planetary gear arrangement or a lay shaft gear arrangement to adjust the mover torque output. Packaging constraints may present certain challenges when mounting and supporting elements of the gear train. Additionally, the vehicle may include an electric machine, such as an electric motor or electric motor generator, with an output that drivingly couples to the gear train. Electric machines may rotate at higher rotational speeds compared to other movers such as internal combustion engines (ICEs). The higher speeds of the electric machine may present challenges with transferring rotational energy across the gear train.

For example, in a lay shaft arrangement, an output bearing may be unsupported, which may lead to premature degradation of the output bearing. Additionally, power transfer through the output bearing may be inefficient, along with increased noise, vibration, and harshness (NVH) that may lead to customer dissatisfaction. There is a demand for an output bearing support that fits a packaging constrained gear train and does not increase a manufacturing complexity.

The inventors have recognized these and other issues with such systems and come up with a way to at least partially solve them. In one example, the issues described above are at least partially solved by an electric motor including an electric motor output shaft, a gear train comprising an input gear coupled to a first gear arranged on a lay shaft, further comprising a second gear arranged on the lay shaft and coupled to an output gear, wherein the input gear is further coupled to the electric motor output shaft and the output gear is coupled to a gear train output shaft, and a support is physically coupled to a housing of the electric motor, wherein the support is configured to support a bearing coupled to the output gear.

The input gear and the output gear may be part of a lay shaft configuration of the gear train. The input gear meshes with a first gear and the output gear meshes with a second gear, where the first gear and second gear are rigidly coupled to a lay shaft. A plurality of mounts may be positioned radially outside of an outer diameter of the output gear. In this way, complexity of manufacturing and installation of the support may be reduced. The housing of the assembly may house the gear train. A larger housing that may house a mover may house or comprise the housing of the assembly. Alternatively, there may be a plurality of housings of the assembly, such as a second housing that houses the mover and physically couples to the housing. An output of the mover rigidly couples or comprises the driving shaft. The mover may be an electric machine, such as an electric motor or an electric motor/generator. A rotor of the electric machine may rigidly couple or comprise the output.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1A shows an example schematic of a first configuration of a vehicle including a gear train of the present disclosure.

FIG. 1B shows an example schematic of a second configuration of the vehicle including one or more gear trains of the present disclosure.

FIG. 1C shows an example schematic of a third configuration of the vehicle including one or more gear trains of the present disclosure.

FIG. 2 shows an example schematic of the gear train including a support bracket of the present disclosure.

FIG. 3 shows an exploded view of an electric machine assembly including a gear train and support bracket of the present disclosure.

FIG. 4 shows a sectional view of a first section of the electric machine assembly.

FIG. 5 shows a side view of the gear train, the support bracket, and a rotor of the electric machine.

FIG. 6 shows a sectional view of the gear train, the support bracket, and the rotor.

FIG. 7 shows a side view of the support bracket separated from other components of the electric machine assembly.

FIG. 8 shows a side view of the gear train, the support bracket, and the rotor.

FIG. 9 shows a sectional view of a second section of the electric machine assembly.

### DETAILED DESCRIPTION

The following description relates to a bracket of an assembly comprising an electric machine and a gear train. The gear train includes an input gear and an output gear. The input gear is a driving gear that may drive and input rotational energy to the gear train. The output gear is a driven gear that may be driven by and output rotational energy from the gear train. The bracket is a support (e.g., a support bracket) for the driven gear and a corresponding bearing to the driven gear.

An input shaft and an output shaft may drivingly couple to the gear train, such as to transfer and receive torque. The input shaft may rigidly couple and drive the input gear. The output shaft may rigidly couple and be driven by the output gear. The support bracket may support a bearing, such that the bearing is centered about a rotational axis of the input shaft and/or the output shaft. The bearing may support the output gear in one example. A housing assembly that may house the gear train and an electric machine may be multiple components comprising a housing. Alternatively, the housing assembly may include other housings. For example, the housing assembly may include a first housing that specifically houses the electric machine and a housing that specifically houses the assembly. For example, the support bracket may be disposed between an electric machine and the output gear.

The support bracket comprises a main body and a plurality of protrusions extending in an outward direction away from the main body, the input shaft, and the output shaft. The protrusions include a plurality of mounts, where each mount includes at least a through-hole configured to receive a fastener. Each mount is at the distal end of a protrusion of the protrusions. The main body comprises an opening. The mounts and distal ends of the bracket may be positioned outward from (e.g., outside of) an outer diameter of the output gear, such that the support may be physically coupled to an electric motor housing.

The main body may include a first rim, a second rim, a shoulder, and a land that shape an opening. The main body may further include a first section and a second section, where the first section includes the first rim and the shoulder, and where the second section includes the second rim and the land. The land extends further in a radially inward direction relative to the one or more rims of the main body. The main body of the support bracket may be configured to support and contact the second bearing via the opening and the surfaces that shape the opening. The main body may curve about and cover a portion of the input gear. The opening may be circular and may surround input gear and the second bearing. At least a portion of the input gear may be surrounded by features of the main body, curving about the input gear. For example, the land may curve about the input gear. Likewise, the shoulder and the first rim may curve about, contact, and support the second bearing. The second section of the main body may include a cutout, where a cutout extends from an outer surface of the main body to one or more inner surfaces of the elevated core and rim. The opening may be open to an exterior of the main body via the cutout.

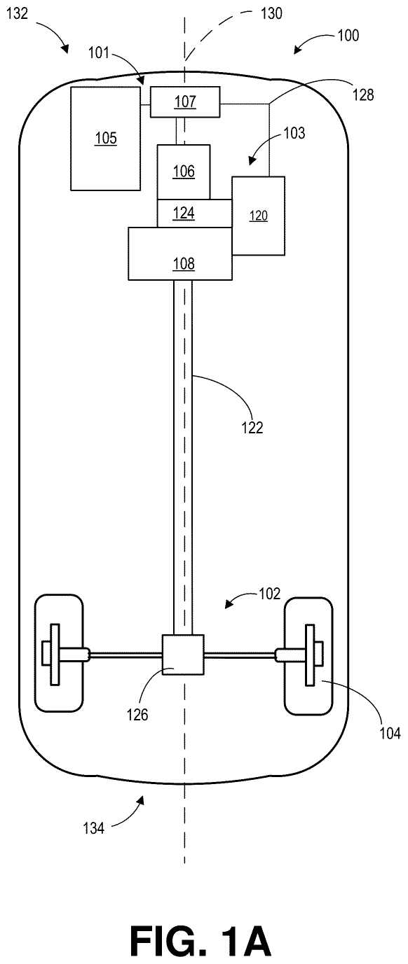

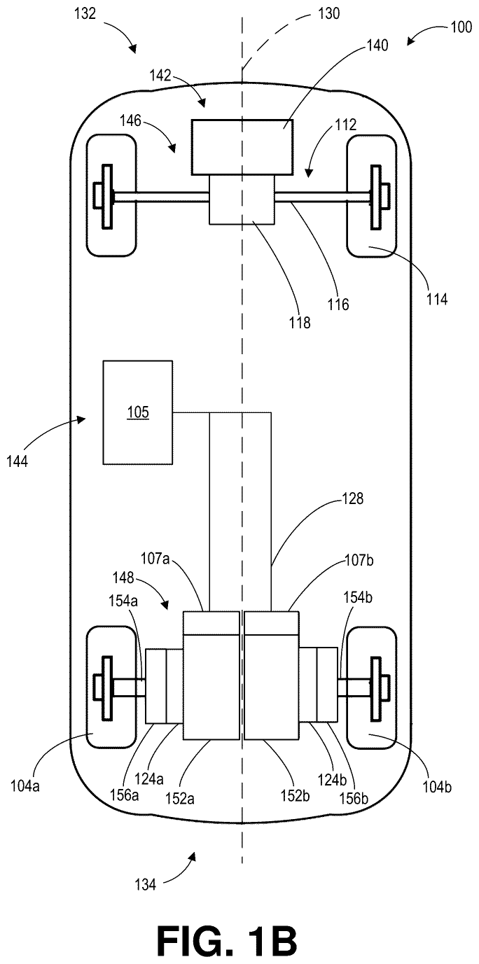

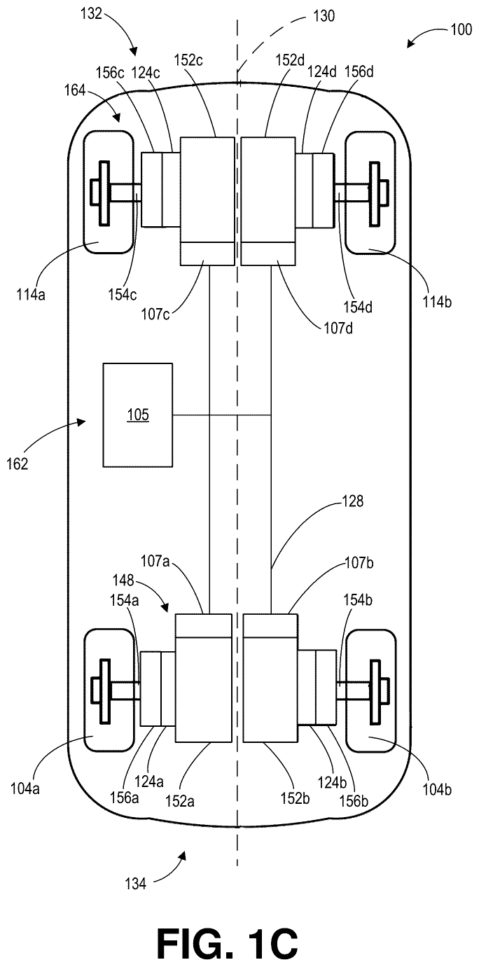

FIG. 1A shows an example schematic of a first configuration of a vehicle including a gear train of the present disclosure. FIG. 1A shows the first configuration is a rear drive configuration, where the transmission may drive a rear axle assembly via a drive shaft and a differential. The gear train is disposed between a mover and a transmission of the vehicle, and may receive rotational power from the mover and distribute rotary power to the transmission or another component of FIG. 1A. FIG. 1B shows an example schematic of a second configuration of the vehicle which may include one or more gear trains of the present disclosure. FIG. 1B shows the second configuration is a front drive configuration, where the transmission may drivingly couple a front axle assembly via a differential. FIG. 1B shows the second configuration is also a rear side configuration, where the movers of the rear side architecture are wheel side movers. FIG. 1C shows an example schematic of a third configuration of the vehicle which may include one or more gear trains of the present disclosure. FIG. 1C shows the third configuration is of a front side and a rear side configuration, where the movers are wheel side movers. The gear trains of FIGS. 1B-1C are disposed between wheel side movers and the wheels of the vehicle.

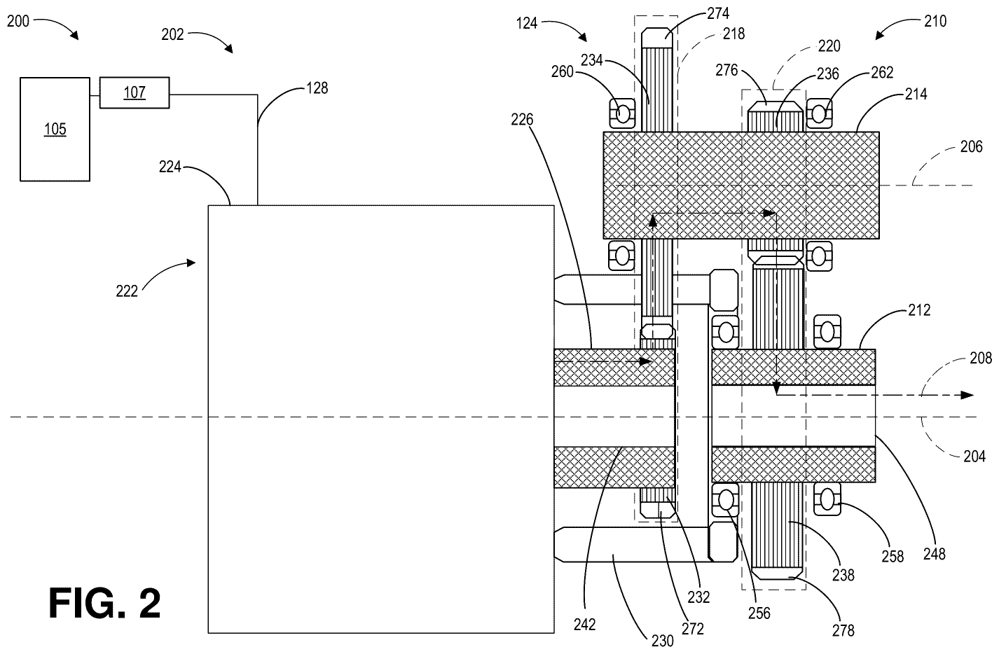

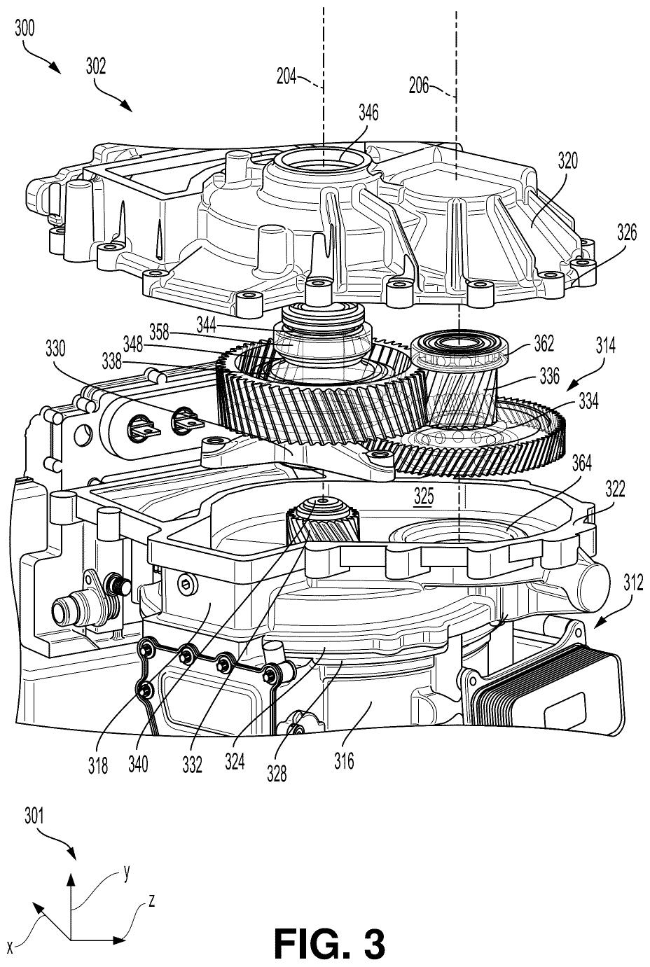

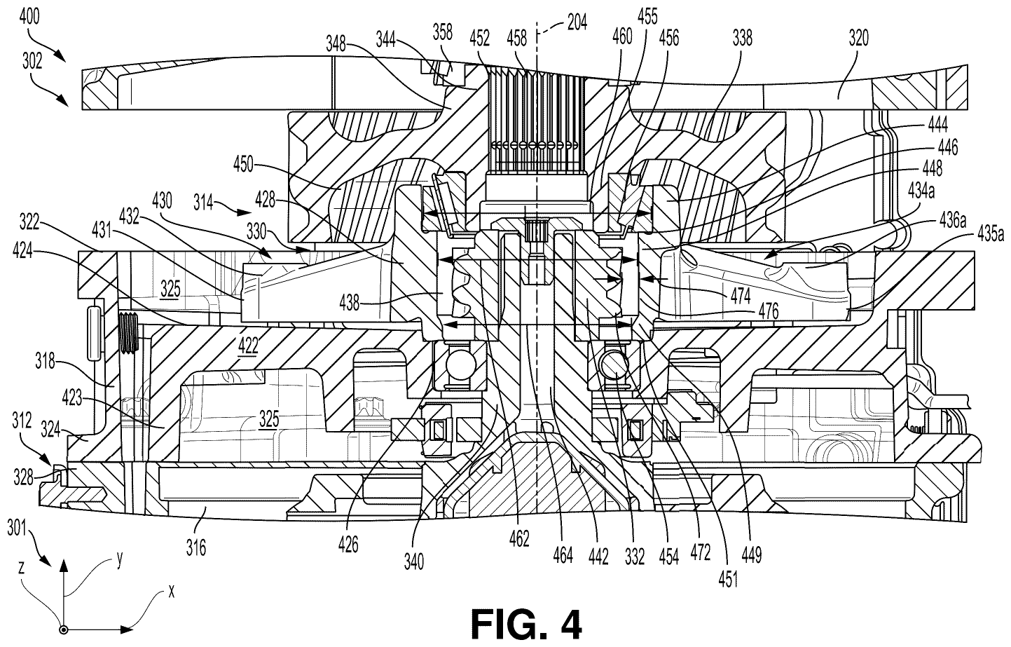

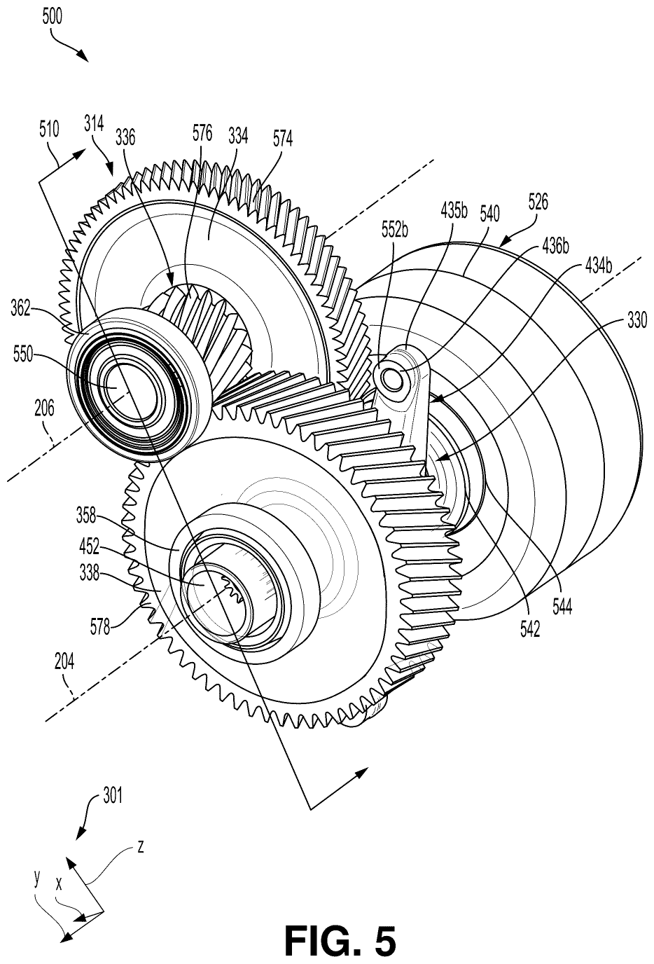

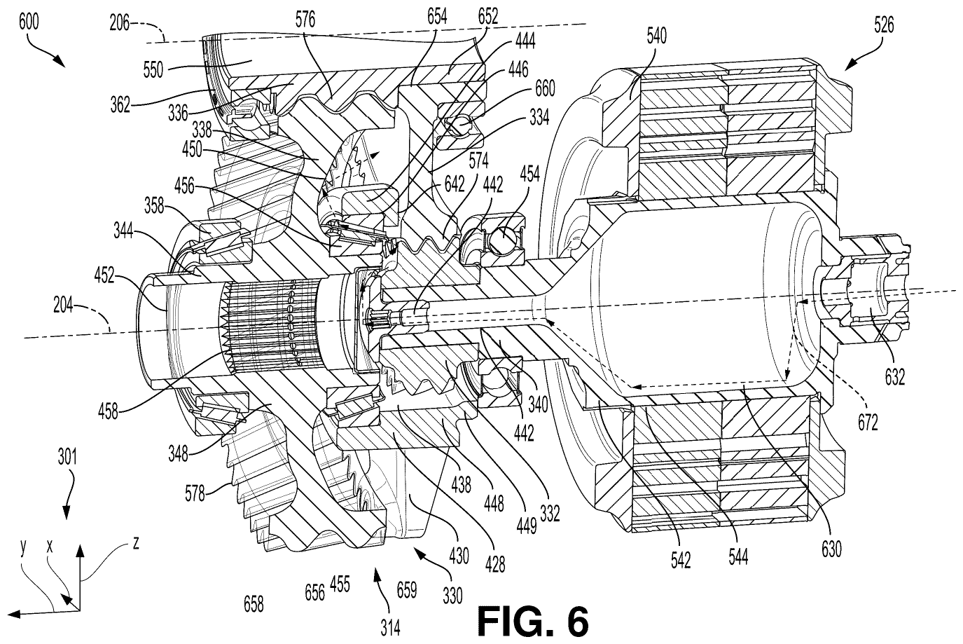

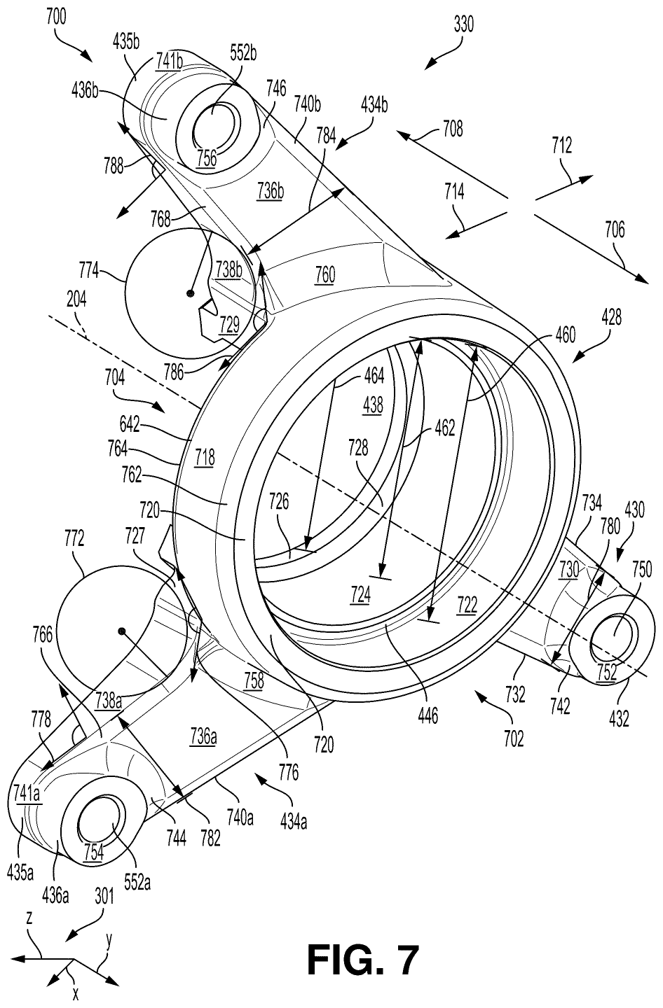

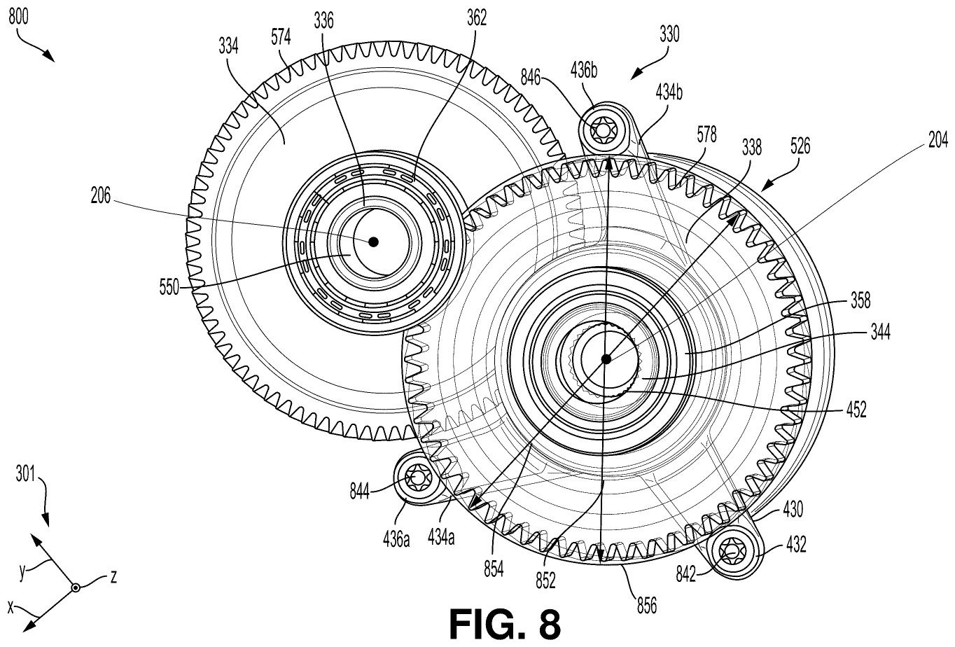

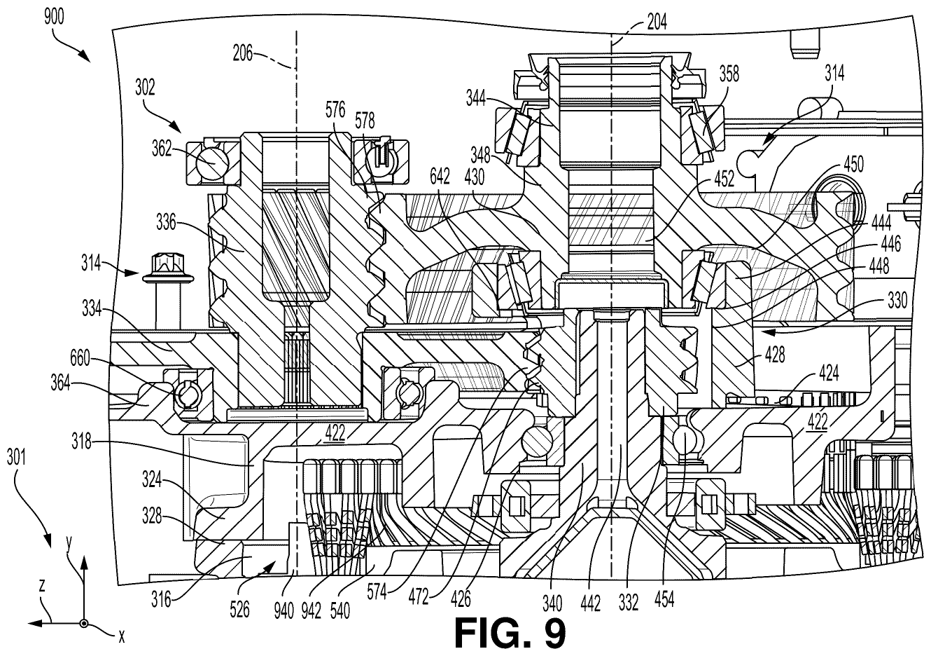

FIG. 2 shows an example schematic of a gear train including a support bracket of the present disclosure. In FIG. 2, the support bracket is physically coupled to a housing of an electric machine that may drive the gear train. The gear train in FIG. 2 is of a lay shaft configuration. FIG. 3 shows an exploded view of an electric machine assembly including a gear train and support bracket of the present disclosure. FIG. 4 shows a sectional view of a first section of the electric machine assembly. FIG. 5 shows a side view of the gear train, the support bracket, and a rotor of an electric machine. FIG. 6 shows a sectional view of the gear train, the support bracket, and the rotor. FIG. 7 shows a side view of the support bracket separated from other components of the electric machine assembly. FIG. 8 shows a side view of the gear train, the support bracket, and the rotor. FIG. 9 shows a sectional view of a second section of the electric machine assembly. The rotor is rotationally coupled to transfer torque to the gear train via an input gear in FIGS. 5-6 and in FIG. 8. The gear train of FIGS. 3-4 and FIG. 9 is of a lay shaft configuration. The gear train and support bracket of FIGS. 3-4 and FIG. 9 are example configurations of the gear train and support bracket of FIG. 2, respectively.

It is also to be understood that the specific assemblies and systems illustrated in the figures, and described below are exemplary embodiments of the inventive concepts defined herein. For purposes of discussion, the drawings are described collectively. Thus, like elements may be commonly referred to herein with like reference numerals and may not be re-introduced.

FIGS. 1A-2 show schematics of example configurations with relative positioning of the various components. FIGS. 3-9 show example configurations with approximate positioning. FIGS. 3-9 are shown approximately to scale; though other relative dimensions may be used. As used herein, the terms “approximately” is construed to mean plus or minus five percent of the range unless otherwise specified.

Further, FIGS. 1A-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified. Features described as tangential may extend linearly from a point on a circumference that is radially about an axis or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

Components described as drivingly coupled are coupled such as to drive one another. Said in another way, a first component drivingly coupled to a second component may drive the second component and vice versa. Said in another way, rotational power may be transferred from a first component to a second component when the first component drivingly couples the second component. A component described as a driving component may drive another component. A component described as a driven component may be driven.

Turning to FIG. 1A, a vehicle 100 is shown of a first configuration that comprises a powertrain 101 and a drivetrain 103. The vehicle 100 may include a gear train of the present disclosure. For example, the vehicle 100 includes a reduction assembly 124 that includes a gear train of the present disclosure. The vehicle 100 may have a front end 132 and a rear end 134, located on opposite sides of vehicle 100. Objects, components, and features of the vehicle 100 referred to as being located near the front may be closest to the front end 132 compared to the rear end 134. Objects, components, and features of the vehicle 100 referred to as being located near the rear may be closest to the rear end 134 compared to the front end 132. The vehicle 100 may have a longitudinal axis 130. The powertrain 101 and drivetrain 103 may each have a length parallel with the longitudinal axis 130.

The vehicle 100 may be a commercial vehicle, light, medium, or heavy duty vehicle, a passenger vehicle, an off-highway vehicle, a commercial vehicle, agricultural vehicle, and/or sport utility vehicle. For an example embodiment, the vehicle 100 may be a wheeled vehicle, such as an automobile. However, additionally or alternatively, the vehicle 100 may be plane, a boat, or other vehicle system that utilizes the gear train of the present disclosure, including the gear train of the reduction assembly 124. Additionally or alternatively, the vehicle 100 and/or one or more of its components, such as components of the powertrain 101 and/or drivetrain 103, may be used in industrial, locomotive, military, agricultural, and/or aerospace applications.

The vehicle 100 may be an all-electric vehicle with one or more of plurality of electric machines configures to supply power to an axle assembly 102. Alternatively, the vehicle 100 may be a hybrid vehicle including both an engine and one or more of a plurality electric machines each configured to supply power to the axle assembly 102. For example, the axle assembly 102 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, the axle assembly 102 may be an electric axle assembly configured to be driven by an integrated electric machine.

The drivetrain 103 includes the axle assembly 102. The axle assembly 102 may be configured to drive a set of wheels 104. For an example, the axle assembly 102 is arranged near the rear of the vehicle 100 and thereby comprises a rear axle. However, it is to be appreciated that the location of the axle assembly 102 may be non-limiting. For another example, the axle assembly 102 may be arranged near the front of the vehicle 100 and thereby comprises a front axle. For another example, the axle assembly 102 may be arranged near another part of the vehicle 100. The drivetrain 103 may output torque to the axle assembly 102. Further, the drivetrain 103 may include one or more tandem axle assemblies. As such, the drivetrain 103 may have other configurations without departing from the scope of this disclosure, and the configuration shown in FIG. 1A is provided for illustration, not limitation. Further, the vehicle 100 may include additional wheels that are not coupled to the drivetrain 103.

The powertrain 101 includes a prime mover 106 and a transmission 108 (e.g., a gear train). For an example the prime mover 106 may be an internal combustion engine (ICE). For another example the prime mover 106 may be an electric machine, such as an electric motor or an electric motor/generator. The prime mover 106 is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting. The reduction assembly 124 may be interposed between the transmission 108 and the prime mover 106. The prime mover 106 may output rotary power to the reduction assembly 124, and the reduction assembly 124 may output rotary power to the transmission 108 or another system.

The vehicle 100 may be of a configuration that has all-electric modes of operation, such as an all-electric vehicle or a plug-in hybrid vehicle. In an all-electric vehicle, the prime mover 106 may be an electric machine. For example, the prime mover 106 may be an electric motor/generator. The vehicle 100 may be a hybrid vehicle, wherein there are multiple torque inputs to the transmission 108. There may be other movers that may drive and be housed by vehicle 100 besides prime mover 106. For example, the vehicle 100 may include a plurality of electric machines 120. A reduction assembly 124 may be interposed between the transmission 108 and one or more of the electric machines 120. An electric machine of the electric machines 120 may output rotary power to the reduction assembly 124, and the reduction assembly 124 may output rotary power to and drive the transmission 108 or another system.

The prime mover 106 may be powered via energy from an energy storage device 105, such as if the prime mover 106 is an electric machine. In one example, the energy storage device 105 is a battery, such as a traction battery, configured to store electrical energy. One or more of a plurality of inverters 107 may be arranged between the energy storage device 105 and the prime mover 106 and configured to adjust direct current (DC) to alternating current (AC). Additionally or alternatively, the electric machines 120 may be powered via electricity from the energy storage device 105. One or more of a plurality of inverters may be arranged between the energy storage device 105 and the electric machines 120 to adjust direct current (DC) to alternating current (AC). The inverters 107 may electrically couple to the energy storage device 105, and the one or more of the inverters 107 may electrically couple to the prime mover 106 and/or electric machines 120. The inverters 107 may include a variety of components and circuitry with thermal demands that effect an efficiency of the inverter. Electrical components may be electrically coupled via a plurality of electrical connections 128.

In some configurations, such as shown in FIG. 1A, the drivetrain 103 includes a driveshaft 122 configured to receive rotary power output by the transmission 108. The driveshaft 122 may drivingly couple and transmit the rotary power from the transmission 108 to the axle assembly 102. The driveshaft 122 may be positioned to extend in parallel with the longitudinal axis 130. For an example of a configuration of vehicle 100, the driveshaft 122 may be centered about the longitudinal axis 130. The driveshaft 122 may drivingly couple and transmit rotary power from the transmission 108 to a differential 126 of the axle assembly 102 to drive the set of wheels 104. The driveshaft 122 may be a rear driveshaft that may transmit rotary power to the rear of the vehicle 100, such as for a rear wheel drive. However, it is to be appreciated that for alternate configurations of the drivetrain 103, the driveshaft 122 may be a front driveshaft, transferring rotary power to the front of the vehicle 100, such as if the axle assembly 102 is at the front of the vehicle 100 and/or for a front wheel drive.

The transmission 108 may be a gearbox or include a gearbox. Alternatively, the transmission 108 may be an axle transmission or a trans axle transmission. The transmission 108 may physically couple to an axle of the vehicle, such as via mounting. In some embodiments, additionally or alternatively, the transmission 108 may be a first transmission, and the vehicle 100 may have a second transmission. A second transmission or additional transmissions may be arranged to physically couple an axle of the vehicle 100, such as the axle of the axle assembly 102. A second transmission or another transmission may be arranged to drivingly couple and output torque to another axle besides the axle of the axle assembly 102.

It is to be appreciated, that for another example of vehicle 100, there may be one or more transmissions that may not output to a driveshaft. For this example, one or more of the transmissions may output directly to an axle shaft and/or a wheel, such as an axle shaft of the axle assembly 102 and/or one or more wheels of wheels 104. Transmissions of this example may be referred to herein as wheel side transmissions. A mover and a gear train may drivingly couple and output torque to the wheel side transmission, where rotary power may flow from the mover to the gear train and from the gear train to the wheel side transmission. For another example, the mover and the gear train may drivingly couple to one or more wheels of the wheels 104. The mover and the gear train may drive one or more wheels, where rotary power may flow from the mover to the gear train and from the gear train to the one or more wheels. The mover is an electric machine, and the gear train is the same configuration as the gear train of reduction assembly 124.

Turning to FIG. 1B, a second example configuration of the vehicle 100 is shown that may comprise a first power train 142 and a first drive train 146. The second example configuration illustrates the vehicle 100 having wheel side movers, wheel side gear trains of the present disclosure, and wheel side transmissions.

The second example configuration of the vehicle 100 may comprise a second power train 144 and a second drive train 148. The first power train 142 provides power to drive the first drive train 146. The second power train 144 provides power to drive the second drive train 148. The first power train 142 and the first drive train 146 may be arranged near the front end 132 of the vehicle 100. Said in another way, the first power train 142 may be a front power train, and the first drive train 146 may be a front drivetrain. Likewise, the second power train 144 and the second drive train 148 may be arranged near the rear end 134 of the vehicle 100. Said in another way, the second power train 144 may be a rear power train, and the second drive train 148 may be a rear drivetrain. However, it is to be appreciated that the location of the first power train 142, the second power train 144, the first drive train 146, and the second drive train 148 may be non-limiting. For example, the first power train 142 and the first drive train 146 may be located nearest to the rear end 134 of the vehicle 100. Likewise, the second power train 144 and the second drive train 148 may be located nearest to the front end 132 of the vehicle 100. Additionally or alternatively, the first power train 142 and the first drive train 146 and/or the second power train 144 and the second drive train 148 may positioned at other locations of the vehicle 100.

The first power train 142 includes at least a first mover 140. The first mover 140 may be a prime mover. For an example of the second configuration, the first mover 140 is an ICE. A power source, such as a fuel storage device, may supply fuel to and be in fluidic communication with the first mover 140. The first drive train 146 includes a second axle assembly 112. The second axle assembly 112 is mounted nearest to the front end 132 of the vehicle; therein, the second axle assembly 112 may be a front mounted axle assembly comprising a front axle. However, it is to be appreciated that the location of the second axle assembly 112 may be non-limiting. For another example, such as if the first drive train 146 is rear mounted, the second axle assembly 112 may be nearest to the rear end 134; therein, the second axle assembly 112 may be a rear mounted axle assembly comprising a rear axle. For another example, the second axle assembly 112 may be arranged near another part of the vehicle 100.

The second axle assembly 112 includes a plurality of the second axle shafts 116 and a transmission 118. Likewise, the second axle assembly 112 may be configured to drive a second set of wheels 114. At least the first mover 140 may be configured to provides rotatory power to and drive the axle shafts 116 of the second axle assembly 112. For example, the second set of wheels 114 may rigidly couple the second axle shafts 116. The second axle assembly 112 may be or include a transaxle; therein, the transmission 118 may be a trans-axle transmission. Rotary power from the first mover 140 may drive the transmission 118 via torque. The first mover 140 may have an input to the transmission 118. Rotary power transferred via the input may drive the transmission 118. The transmission 118 drivingly couples to the second axle shafts 116, such as to be configured to drive the second axle shafts 116.

The second power train 144 may include a second mover and a third mover that are wheel side movers. The second and third mover may be configured output rotary power to and drive a specific wheel. For example, the second mover may be a first electric machine 152a, and the second mover may be a second electric machine 152b. The first electric machine 152a and the second electric machine 152b are wheel side electric machines. More specifically, the first electric machine 152a and the second electric machine 152b may be wheel side motors or wheel side motors/generators. The first and second electric machines 152a, 152b may each generate rotary power and drive an axle shaft and/or a wheel. The first electric machine 152a may be configured to drive a first wheel 104a. Likewise, the second electric machine 152b may be configured drive a second wheel 104b. The second power train 144 may also include the energy storage device 105.

The first and second electric machines 152a, 152b may be powered via energy from the energy storage device 105. One or more of a plurality of inverters may be arranged between the energy storage device 105 and the first and second electric machines 152a, 152b. The inverters may be configured to adjust direct current (DC) to alternating current (AC). For example, a first inverter 107a and a second inverter 107b may electrically couple to the energy storage device 105. The first inverter 107a may electrically couple to the first electric machine 152a and electrically couple the first electric machine 152a to the energy storage device 105. Likewise, the second inverter 107b may electrically couple to the second electric machine 152b and electrically couple the second electric machine 152b to the energy storage device 105.

The first and second inverters 107a, 107b may include a variety of components and circuitry with thermal demands that effect an efficiency of the inverter. Electrical components, including the first and second inverters 107a, 107b; the first and second electric machines 152a, 152b, and the energy storage device 105 may be electrically coupled via the electrical connections 128.

The second drive train 148 may include a first reduction assembly 124a, a second reduction assembly 124b, the first wheel 104a, and the second wheel 104b. Likewise, the second drive train 148 may include a first transmission 156a and a second transmission 156b. The first reduction assembly 124a and the second reduction assembly 124b may each be gearboxes. Likewise, the first transmission 156a and the second transmission 156b may each be gearboxes.

The first electric machine 152a may be configured to drive the first reduction assembly 124a. The first reduction assembly 124a may be configured to drivingly couple and drive the first wheel 104a. A first wheel shaft 154a may rigidly couple to the first wheel 104a. The first reduction assembly 124a may be configured to drive the first wheel shaft 154a. For example, the output of the first reduction assembly 124a may rigidly couple to the first wheel shaft 154a. For another example, the first transmission 156a may be disposed between the first reduction assembly 124a and the first wheel shaft 154a. The first reduction assembly 124a may be configured to drive the first transmission 156a, and the first transmission 156a may be configured to drive the first wheel shaft 154a.

The second electric machine 152b may be configured to drive the second reduction assembly 124b. The second reduction assembly 124b may be configured to drivingly couple and drive the second wheel 104b. A second wheel shaft 154b may rigidly couple to the second wheel 104b. The second reduction assembly 124b may be configured to drive the second wheel shaft 154b. For example, the output of the second reduction assembly 124b may rigidly couple to the second wheel shaft 154b. For another example, the second transmission 156b may be disposed between the second reduction assembly 124b and the second wheel shaft 154b. The second reduction assembly 124b may be configured to drive the second transmission 156b, and the second transmission 156b may be configured to drive the second wheel shaft 154b.

Turning to FIG. 1C, a third example configuration of the vehicle 100 is shown that may comprise a third power train 162 and a third drive train 164. Likewise, the second example configuration of the vehicle 100 includes the second drive train 148. The third power train 162 may provide power to drive the second drive train 148 and the third drive train 164. The third drive train 164 may be arranged near the front end 132 of the vehicle 100; therein, the third drive train 164 may be a front drivetrain. However, it is to be appreciated that the location of the third drive train 164 may be non-limiting. For example, the third drive train 164 may be located nearest to the rear end 134 of the vehicle 100. Additionally or alternatively, the third drive train 164 may positioned at another location of the vehicle 100.

The third power train 162 may include a fourth mover and a fifth mover that are wheel side movers. The fourth and fifth movers may be configured output rotary power and drive a specific wheel. For example, the fourth mover may be a third electric machine 152c. Likewise, the fifth mover may be a fourth electric machine 152d. The third electric machine 152c and the fourth electric machine 152d are wheel side electric machines. More specifically, the third electric machine 152c and the fourth electric machine 152d may be wheel side motors or wheel side motors/generators. The third and fourth electric machines 152c, 152d may each provide rotary power to drive an axle shaft and/or a wheel. The third electric machine 152c may be configured to output rotational energy to and drive a third wheel 114a. Likewise, the fourth electric machine 152d may be configured to output rotational energy and drive a fourth wheel 114b. The third power train 162 may also include the energy storage device 105.

The third and fourth electric machines 152c, 152d may be powered via energy from the energy storage device 105. One or more of a plurality of inverters may be arranged between the energy storage device 105 and the third and fourth electric machines 152c, 152d. The inverters may be configured to adjust direct current (DC) to alternating current (AC). For example, a third inverter 107c and a fourth inverter 107d may electrically couple to the energy storage device 105. The third inverter 107c may electrically couple to the third electric machine 152c, and electrically couple the third electric machine 152c to the energy storage device 105. Likewise, the fourth inverter 107d may electrically couple to the fourth electric machine 152d, and electrically couple the fourth electric machine 152d to the energy storage device 105.

The third and fourth inverters 107c, 107d may include a variety of components and circuitry with thermal demands that effect an efficiency of the inverter. Electrical components, including the third and fourth inverters 107c, 107d; the first and second electric machines 152a, 152b, and the energy storage device 105 may be electrically coupled via the electrical connections 128.

The third drive train 164 may include a third reduction assembly 124c, a fourth reduction assembly 124d, the third wheel 114a, and the fourth wheel 114b. Likewise, the third drive train 164 may include a third transmission 156c and a fourth transmission 156d. The third reduction assembly 124c and the fourth reduction assembly 124d may each be gearboxes including a gear train. Likewise, the third transmission 156c and the fourth transmission 156d may each be gearboxes.

The third electric machine 152c may be configured to drive the third reduction assembly 124c. The third reduction assembly 124c may be configured to drivingly couple and drive the third wheel 114a. A third wheel shaft 154c may rigidly couple to the third wheel 114a. Likewise, an output of the third reduction assembly 124c may be configured to drive the third wheel shaft 154c. For example, the output of the third reduction assembly 124c may rigidly couple to the third wheel shaft 154c. For another example, the third transmission 156c may be disposed between the third reduction assembly 124c and the third wheel shaft 154c. The third reduction assembly 124c may be configured to drive the third transmission 156c, and the third transmission 156c may be configured to drive the third wheel shaft 154c.

The fourth electric machine 152d may be configured to drive a fourth reduction assembly 124d. The fourth reduction assembly 124d may be configured to drivingly couple and drive the fourth wheel 114b. A fourth wheel shaft 154d may rigidly couple to the fourth wheel 114b. Likewise, an output of the fourth reduction assembly 124d may be configured to drive the fourth wheel shaft 154d. For example, the output of the fourth reduction assembly 124d may rigidly couple to the fourth wheel shaft 154d. For another example, the fourth transmission 156d may be disposed between the fourth reduction assembly 124d and the fourth wheel shaft 154d. The fourth reduction assembly 124d may be configured to drive the fourth transmission 156d, and the fourth transmission 156d may be configured to drive the fourth wheel shaft 154d.

The reduction assembly 124 of FIG. 1A, the first and second reduction assemblies 124a, 124b of FIGS. 1B-1C, and the third and fourth reduction assemblies 124c, 124d of FIG. 1C, may be gearboxes including gear trains of a layshaft configuration of the present disclosure. Furthermore, the gear trains of the reduction assembly 124, the first and second reduction assemblies 124a, 124b, and the third and fourth reduction assemblies 124c, 124d may be supported by a support structure of the present disclosure.

Turning to FIG. 2, it shows a schematic 200 of a system 202. The system 202 includes a first axis 204 and a second axis 206. Rotary power may flow through the system 202 as indicated by arrows 208. The gear train 210 may include a lay shaft configuration, including a first shaft 212 and a second shaft 214, where the second shaft 214 may be a lay shaft. The first shaft 212 may be a driven shaft, that is driven via power from the gear train 210. The gear train 210 may also include a driving shaft, where the driving shaft may drive and transfer power to the gear train 210. The driving shaft may be an input shaft to and the driven shaft may be an output shaft from the gear train 210.

The gear train 210 includes a first gearset 218 and a second gearset 220. The first shaft 212 and the second shaft 214 may be centered around the first axis 204 and the second axis 206, respectively. The electric machine 222 may drivingly couple the gear train 210 via the first gearset 218, where the first gearset 218 may drivingly couple such as transfer rotary power to the second shaft 214. Herein, drivingly coupled may be used to describe two components that may transfer mechanical power to one another or in only a single direction. Ways of drivingly coupling components may include meshed engagements and direct physical couplings such as welds, fusions, fasteners, adhesives, and the like. The second shaft 214 may drivingly couple to the first shaft 212 via the second gearset 220, where the second gearset 220 may transfer rotary power to the first shaft 212 from the second shaft 214. The gear train 210 may be a configuration of the gear train of reduction assembly 124 of FIG. 1A. Likewise, the gear train 210 may be a configuration of the gear trains of the reduction assemblies 124a, 124b, 124c, and 124d of FIGS. 1B-1C.

The electric machine 222 may receive electrical energy from an energy storage device, such as via the energy storage device 105. One or more of a plurality of inverters 107 may be arranged between the energy storage device 105 and the electric machine 222. The electric machine 222 may be the prime mover 106 or one of the one or more electric machines 120 of FIG. 1A. Additionally or alternatively, the electric machine 222 may be the electric machines 152a, 152b, 152c, and 152d of FIGS. 1B-1C. The electric machine 222 includes a housing 224. The first axis 204 may be the rotational axis for the electric machine 222. A rotor of the electric machine 222 may rigidly couple to or comprise the output 226. The electric machine 222 may include an output 226. The output 226 may be a rotational element, such as a motor shaft, that may drivingly couple and transfer rotational energy to another rotational element. The output 226 is an output shaft of the electric machine 222, in one example. Herein, the output 226 may be interchangeably referred to as an electric machine output shaft and/or an output shaft. For an example, the output 226 may drivingly couple to the first gearset 218, such as via rigidly coupling to a gear of the first gearset 218.

The gear train 210 may include at least a first gear 232, a second gear 234, a third gear 236, and a fourth gear 238. The first gear 232 is an input gear to the gear train 210, via which rotary power may be transferred to the gear train 210. The fourth gear 238 is an output gear of the gear train 210, via which rotary power may be transferred from the gear train 210 to an output component, such as a wheel, a differential, or an auxiliary device. The first gear 232 and the fourth gear 238 may be co-axial, where the first gear 232 and the fourth gear 238 are radially about, such as radially around, a common axis. For example, the first gear 232 and fourth gear 238 may be co-axial about the first axis 204. The output 226 may be rigidly coupled to the first gear 232. The fourth gear 238 may be rigidly coupled to the first shaft 212. Alternatively, the fourth gear 238 and the first shaft 212 may be comprised by a unitary rotational component. The gear train 210 may be drivingly coupled to an outlet component via the first shaft 212. The outlet component may be rotational element, such as a gear or a wheel, or a system of rotational elements, such as a differential or another gearset.

The second gear 234 and the third gear 236 may be co-axial. For example, the second gear 234 and the third gear 236 may be centered radially about the second axis 206. The second and third gears 234, 236 may drivingly couple to the second shaft 214, such as to transfer rotary power to and from the second shaft 214, such as via torque. The second and third gears 234, 236 may be rigidly coupled to the second shaft 214, and therein may be lay shaft gears. For example, the second gear 234 may be a first lay shaft gear that may be an input to the second shaft 214 from the first gearset 218. The third gear 236 may be a second lay shaft gear that may be an output from the second shaft 214 to the second gearset 220. The second shaft 214 may join to or comprise the third gear 236, such that the second shaft 214 and the third gear 236 are a unitary component. Additionally or alternatively, the second shaft 214 may comprise the fourth gear 238, such that the second shaft 214 and fourth gear 238 are a unitary component.

The gear train 210 also includes a support 230. The support 230 may be a stationary structure, such as a bracket, to support the first shaft 212. Said in another way, the support 230 may be a support bracket for the first shaft 212. The support 230 may physically couple the electric machine 222, such as through physically coupling the housing 224. The support 230 may be disposed between the electric machine 222 and the fourth gear 238 along a common axis, such as the first axis 204. The support 230 may be physically coupled via fastening with a plurality of fasteners. The support 230 may support the first shaft 212, such that the first shaft 212 is centered about the first axis 204 and may rotate freely of the support 230. Physically coupling the support 230 to the electric machine 222 may keep the output 226, and the first shaft 212 aligned such as to be co-axial when forces are placed on the system 202, such as sheer forces, deflective forces, and forces from the vibration of the electric machine 222 at rotational speeds above a threshold, such as above 500 rotations per minute (RPM).

Rotational elements, including the output 226 and the first shaft 212 may be hollow having one or more volumes. The one or more volumes may house and transport fluid, such as lubricant and/or coolant. The output 226 may be hollow or partially hollow and include volumes such as a volume 242. The volume 242 may be a passage via which lubricant and/or coolant may flow. The volume 242 may be centered on the first axis 204. The volume 242 may extend through the output 226, where the output 226 may curve radially about the volume 242. Likewise, the first shaft 212 may be hollow including at least a volume such as a first passage 248. The first passage 248 may be concentric to the first shaft 212 and centered about the first axis 204. The volume 242 and the first passage 248 may be co-axial with a gap arranged therebetween such that the two volumes are separated. In this way, the output 226 may be spaced away from and not coupled to the first shaft 212.

The rotational elements of the system 202 may be supported by one or more bearing assemblies to allow for rotation/spinning from a housing that houses components of the system 202 or other stationary component relative to the rotational elements. A first bearing assembly 256 and a second bearing assembly 258 may support the first shaft 212. The first bearing assembly 256 and the second bearing assembly 258 may be positioned radially around and in surface sharing contact with the first shaft 212. The first bearing assembly 256 may be sandwiched radially between the support 230 and the first shaft 212, where the support 230 supports the first bearing assembly 256. The support 230 may be disposed between the first bearing assembly 256 and the fourth gear 238 along a common axis, such as the first axis 204. A third bearing assembly 260 and a fourth bearing assembly 262 may support the second shaft 214. The third bearing assembly 260 and the fourth bearing assembly 262 may be positioned radially around and in surface sharing contact with the second shaft 214. The bearing assemblies 256, 258, 260, and 262 may each include one or more bearings.

The first gear 232 include a plurality of first teeth 272 that may mesh with a plurality of second teeth 274 of the second gear 234. Likewise, the third gear 236 includes a plurality of third teeth 276 that may mesh with a plurality of fourth teeth 278 of the fourth gear 238.

The power flow represented by arrows 208 may be a flow of rotary power generated via rotational energy, and may be transferred via torque. The power flow may be generated via electric machine 222 via spinning of a rotor from electrical current. The power flow starts at the output 226, where rotary power is transferred from the output 226 to the first gearset 218, via the first gear 232. The first gearset 218 is driven via the first gear 232. Rotary power is transferred to the second shaft 214 via the second gear 234. The second shaft 214 is driven with the second gear 234. Rotary power is transferred from the second shaft 214 to the second gearset 220 via the third gear 236. The second gearset 220 is driven via the third gear 236. Rotational energy may be transferred from the second gearset 220 to the first shaft 212 via the fourth gear 238. The first shaft 212 is driven with the fourth gear 238. Rotary power may exit the system 202 via the first shaft 212. Rotary power may be received by an outlet component may be drivingly coupled to and driven by the first shaft 212.

A set of reference axes 301 are provided for comparison between views shown in FIG. 3. The reference axes 301 indicate a y-axis, an x-axis, and a z-axis. In an example, the z-axis may be parallel with a direction of gravity, and the x-y plane may be parallel with a horizontal plane that an assembly 302 of FIG. 3 may rest upon. In another example, the z-axis may be parallel with a direction of gravity, and the x-y plane may be parallel with a horizontal plane that a gear train 314 and the rotor assembly 526 of FIG. 5 may rest upon. Further, in another example, the z-axis may be parallel with a direction of gravity, and the x-y plane may be parallel with a horizontal plane that a bracket 330 of FIG. 7 may rest upon. When referencing direction, positive may refer to in the direction of the arrow of the y-axis, x-axis, and z-axis and negative may refer to in the opposite direction of the arrow of the y-axis, x-axis, and z-axis. A circle may represent an axis of the reference axes 301 that is normal to a view. A circle may represent an axis of the reference axes 301 that is normal to a view. A filled circle may represent an arrow and axis facing toward, or positive to, a view. An unfilled circle may represent an arrow and an axis facing away, or negative to, a view.

Turning to FIG. 3, it shows a first view 300 of a gear train 314. The first view 300 is an exploded view, showing housings covers and other components exploded such that a gear train 314 of the assembly 302 is shown. An assembly 302 may include an electric machine 312 and the gear train 314. The electric machine 312 and the gear train 314 may be the electric machine 222 and the gear train 210 of FIG. 2, respectively. The assembly 302 may be arranged with the first axis 204 and the second axis 206 that are rotational axes for rotational components of the electric machine 312 and gear train 314 to rotate and/or spin about. The first and second axes 204, 206 are longitudinal axes, parallel with the y-axis of the reference axes 301.

The assembly 302 may include a plurality of housings, such as a first housing 316 and a second housing 318. In one example, the first housing 316 is an electric motor housing and the second housing 318 is a gear train housing. The first housing 316 houses the electric machine 312, including a portion of an output 340. The output 340 is a rotational element that may be driven via the electric machine 312. The output 340 may extend into the second housing 318. The second housing 318 may house the gear train 314. The second housing 318 may physically couple to a cover 320. The cover 320 and the second housing 318 may enclose the gear train 314. The output 340 may be an input shaft to the gear train 314, and therein may couple to and drive an input gear. The cover 320 may be a bellhousing including a plurality of cavities and other volumes that seals the second housing. A cavity 325 may be arranged within the second housing 318 and corresponding to a volume in which the gear train 314 is arranged. The second housing 318 may include a first flange 322 and a second flange 324 for physically coupling to the cover 320 and first housing 316, respectively. The first flange 322 may physically couple to a third flange 326 of the cover 320. The second flange 324 may physically couple to a fourth flange 328 of the first housing 316.

The gear train 314 may include a first gear 332, a second gear 334, a third gear 336, and a fourth gear 338. The gear train 314 may be at least partially supported by a bracket 330. More specifically, the bracket 330 may support and curve around the fourth gear 338 via supporting an output bearing. The output bearing may support the fourth gear 338 and/or a shaft 344. The shaft 344 may be an output shaft of the gear train 314. The first gear 332, the second gear 334, the third gear 336, and the fourth gear 338 may be example configurations of the first gear 232, the second gear 234, the third gear 236, and the fourth gear 238 of FIG. 2, respectively. Likewise, the bracket 330 may be an example configuration of support 230 of FIG. 2, which are both configured as a single piece. The first gear 332 may couple to the output 340. The output 340, first gear 332, and fourth gear 338 may be aligned such as to be co-axial with and centered about the first axis 204. The first axis 204 may be a rotational axis that the output 340, the first gear 332, and the fourth gear 338 may spin about.

The shaft 344 may be coupled to the fourth gear 338. The shaft 344 may extend outward along the first axis 204 from fourth gear 338. An opening 346 of the cover 320 may receive the shaft 344. The shaft 344 may include a land 348, where the land 348 extends in a radial direction from the shaft 344. The land 348 may comprise a shoulder that may support and abut a first bearing assembly 358. The shaft 344 may be an output shaft. For example, the shaft 344 may be the first shaft 212 of FIG. 1A. Additionally or alternatively, the shaft 344 may an output shaft and be referred to alternatively herein as the gear train output shaft 344. The third gear 336 and a corresponding shaft may be supported by a second bearing assembly 362. The first bearing assembly 358 and the second bearing assembly 362 may be example configurations of the second bearing assembly 258 and fourth bearing assembly 262 of FIG. 2, respectively.

The second housing 318 may include a mounted carrier 364. The mounted carrier 364 may be a ring like structure, such as a rim, that extends in a longitudinal direction from the second housing 318. The mounted carrier 364 may support the second gear 334.

Turning to FIG. 4, it shows a second view 400 of the assembly 302. The second view 400 is a sectional view, showing the assembly 302 sectioned by a view plane parallel to a plane formed by the x-axis and y-axis of the reference axes 301.

The second housing 318 includes a platform 422 raised in a longitudinal direction from the fourth flange 328. The platform 422 may have a supporting structure 423 that contacts a feature of the first housing 316, such as the fourth flange 328. The platform 422 may comprise a surface 424 and a first passage 426. The surface 424 may be normal to the first and second axes 204, 206. The surface 424 may be a mounting surface, via which the bracket 330 may be physically coupled. The first passage 426 may receive the output 340. The output 340 may drivingly couple, such as via rigidly coupling, to the first gear 332 via the first passage 426. The output 340 may include a second passage 442 via which fluid, such as lubricant, may flow from the electric machine to the gear train 314. The bracket 330 may be configured to collect and redirect lubricant from a center of the output 340 to gears arranged on a lay shaft and to a bearing in face-sharing contact with the bracket 330. The second passage 442 may be or may be part of the volume 242 of FIG. 2.

The bracket 330 includes a main body 428 and a plurality of protrusions. The plurality of protrusions extends outward from main body 428, where outward is relative to a central axis or centerline of the main body 428. The main body 428 may be centered around the first axis 204, such that a central axis and centerline of the main body 428 may be co-axial with the first axis 204. The plurality of protrusions may be interchangeably referred to herein as a plurality of arms. The protrusions may include a first protrusion 430 and a second protrusion 434a. The first protrusion 430 and the second protrusion 434a may be arms. The first protrusion 430 and second protrusion 434a may physically couple to the platform 422 via fastening. The first protrusion 430 includes a first mount 432 and the second protrusion 434a includes a second mount 436a. The first mount 432 may be part of a first distal end 431 of the first protrusion 430 and the bracket 330. Likewise, the second mount 436a may part of a second distal end 435a of second protrusion 434a and the bracket 330. The first mount 432 and the second mount 436a may contact, abut, and physically couple to the surface 424. One or more fasteners complementary to the first mount 432, where the fasteners may fasten the first mount 432 to a complementary structure. A complementary structure, may be a feature the fasteners are fastened to when the fasteners are received by the bracket 330. The complementary structure may have fastening features that the fasteners may fasten to. Fastening features may include holes, such as threaded holes. Likewise, one or more fasteners may be complementary to the second mount 436a, where the fasteners may be received by and may extend through the second mount 436a.

As an example, the complementary structure for the first mount 432, the second mount 436a, and their respective fasteners may be the second housing 318. More specifically, the second structure for the first mount 432, the second mount 436a, and their respective fasteners may be the platform 422. When fastened to the platform 422, the third mount 436b may contact, abut, and physically couple to the surface 424 of FIG. 4. For another example, another complementary structure for the protrusions and their respective mounts may be part of the first housing 316.

The main body 428 comprises a first section and a second section about an opening 438. The opening 438 may be annular in shape. The opening 438 may be centered about the first axis 204. More specifically, the opening 438 may surround the first axis 204, such that a central axis or a centerline of the opening 438 may be co-axial with the first axis 204. The first section of the main body 428 includes a first rim 444 and a shoulder 446, and a portion of an inner land 448. The second section includes another portion of the inner land 448 and a second rim 449. The first rim 444, the shoulder 446, the inner land 448, and the second rim 449 may curve around and form the shape of the opening 438. The first rim 444 is closest to a first side and the second rim 449 is closest to a second side of the bracket 330, where the first side is opposite the second side. The first rim 444 connects to the shoulder 446. The shoulder 446 is connected to the second rim 449 via the inner land 448. The first rim 444 may have a ring like shape. The second rim 449 may have a more frustoconical shape.

The fourth gear 338 may comprise a cavity 450 that may curve about and cover the bracket 330. Said another way, the fourth gear 338 may be supported by a fourth bearing assembly 456 that is in face-sharing contact with the bracket 330. The fourth gear 338 may be spaced away from and does not touch the bracket 330. The cavity 450 may receive and cover the first rim 444. The fourth gear 338 and/or the output shaft 344 may comprise a fourth passage 452. The fourth passage 452 may be a passage, such as the first passage 248 of FIG. 2. The fourth passage 452 extends through the output shaft 344 and/or fourth gear 338. Another shaft may be received by the fourth passage 452 may rigidly couple to the output shaft 344 and fourth gear 338, referred to herein as a received shaft. The shaft 344 has a plurality of splines 458 that face inward toward and be radially about the fourth passage 452. The splines 458 may be female splines and may mesh with male splines of the received shaft. The platform 422 may comprise a recess 451. The recess 451 may be connected to and contiguous with the first passage 426. The recess 451 may include a platform that the second rim 449 may abut. The platform of the recess 451 may include a counter-hole that extends radially from the first passage 426.

In one example, the fourth bearing assembly 456 is an output gear bearing that is in face-sharing contact with the bracket 330 (e.g., support 230 of FIG. 2). The fourth gear 338 is an output gear of the gear train that is spaced away from and does not touch the bracket 330.

A third bearing assembly 454 may be fit to, contact, and be supported by the first passage 426. The third bearing assembly 454 may be retained by the bracket 330, where the third bearing assembly 454 is housed via the first passage 426, in one example. The third bearing assembly 454 may be retained by the platform 422 and the second housing 318. The second rim 449 may abut and contact the third bearing assembly 454. The third bearing assembly 454 may support the output 340, allowing the output 340 to rotate freely of the platform 422 and second housing 318. In one example, the third bearing assembly 454 is an electric motor output shaft bearing, wherein the bracket 330 extends across an entirety of a portion of the electric motor output shaft that extends into the second housing 318. The main body 428 and the opening 438 may house and receive at least a bearing and at least a gear. For example, the main body 428 and the opening 438 may house and receive the first gear 332 and the fourth bearing assembly 456. The main body 428 may cover the first gear 332. The fourth bearing assembly 456 may be fit to and retained by the first rim 444 and the shoulder 446. The fourth bearing assembly 456 may be positioned radially about and contact the fourth gear 338, such as an extension 455 of the fourth gear 338. The fourth bearing assembly 456 may be sandwiched radially between the first rim 444 and the extension 455. The fourth bearing assembly 456 may be the first bearing assembly 256 of FIG. 2.

The main body 428 may have a plurality of inner diameters. For example, the main body 428 may have three inner diameters, including a first diameter 460, a second diameter 462, and a third diameter 464. The first diameter 460, the second diameter 462, and the third diameter 464 are inner diameters of the opening 438, where the opening 438 changes in width. The first diameter 460 is the inner diameter of the first rim 444. The second diameter 462 is the inner diameter of the inner land 448. The third diameter 464 is the inner diameter of the second rim 449. The first diameter 460 and the second diameter 462 may be constant in a longitudinal direction. The third diameter 464 may change in a longitudinal direction. For example, the third diameter 464 may increase in size in a longitudinal direction toward the fourth gear 338 (e.g., in a positive y direction). Likewise, the third diameter 464 may decrease in a longitudinal direction at positions closer to the electric machine 312 (e.g., in a negative y direction).

The first gear 332 has a plurality of first teeth 472. The second diameter 462 is a size such that there is a distance 474 between an inner surface 476 of the inner land 448 and tips of the first teeth 472. The distance 474 prevents the first teeth 472 or other portions of the first gear 332 from contacting the main body 428.

Turning to FIG. 5, it shows a third view 500 of the gear train 314 and a rotor assembly 526. The third view 500 is a side view. The gear train 314 and the rotor assembly 526 may be divided by a line 510. The line 510 may be parallel with the z-axis of the reference axes 301. Line 510 may intersect and be perpendicular to the first axis 204 and the second axis 206. A sectional view may be taken on line 510 on a view plane parallel with a plane formed by the y-axis and the z-axis of the reference axes 301. The rotor assembly 526 may be the rotor of the electric machine 312. The rotor assembly 526 may be drivingly coupled via the output 340 and the first gear 332 to the gear train 314, such as to output rotational energy to and drive gear train 314. The rotor assembly 526 may be centered on the first axis 204, such that the first axis 204 may be a rotational axis of the rotor assembly 526.

The rotor assembly 526 may include a body 540 and a shaft 542. For an example, the body 540 may house one or more of a plurality of permanent magnets or permanent magnetic components. For another example, the body 540 may house a one or more of a plurality of electromagnetic components, such as windings. The shaft 542 may rigidly couple the body 540, such that the shaft 542 may be spun via spinning the body 540. The body 540 may include a passage 544 that may receive and rigidly couple to the shaft 542. The shaft 542 may comprise or rigidly couple to the output 340. The shaft 542 may be centered on the first axis 204, such that the shaft 542 may spin around the first axis 204. The first axis 204 may therein be a rotational axis for the shaft 542.

The third view 500, shows the bracket 330 includes a third protrusion 434b that extends outward from the main body 428 of FIG. 4. The third protrusion 434b may be an arm. The third protrusion 434b comprises a third mount 436b. The third mount 436b may be located at a third distal end 435b of the third protrusion 434b. Like the first protrusion 430 and the second protrusion 434a, the third protrusion 434b may fasten to the assembly 302. For example, the third protrusion 434b may physically couple to the platform 422 and/or second housing 318 of FIG. 4 via fastening. When fastened to the platform 422, the third mount 436b may contact, abut, and physically couple to the surface 424 of FIG. 4. One or more fasteners, complementary to the third mount 436b, such that the fasteners may be fit to the third mount 436b and a complementary hole of the platform 422, fastening the third protrusion 434b to the surface 424. For example, the third mount 436b may include a fit 552b. The fit 552b may receive a complementary fastener that may fasten the third mount 436b and the third protrusion 434b to the second housing 318. The fit 552b may be a through-hole.

The third view 500 shows the third gear 336 may be hollow, including a fifth passage 550 of the gear train 314. Fluid, such as lubricant, may be passed through the fifth passage 550. The fifth passage 550 may be centered around the second axis 206, such as to be radially about the second axis 206.

Like the first gear 332 of FIG. 3, the second gear 334 includes a plurality of second teeth 574, the third gear 336 includes a plurality of third teeth 576, and the fourth gear 338 includes a plurality of fourth teeth 578.

Turning to FIG. 6, it shows a fourth view 600 of the gear train 314 and the rotor assembly 526. The fourth view 600 is a sectional view, where the fourth view 600 is taken on the line 510 of FIG. 5. The fourth view 600 is taken on a view plane that includes the first axis 204 and the second axis 206.

The fourth view 600 shows the rotor assembly 526 includes a cavity 630 and a passage 632. The shaft 542 may comprise the cavity 630 and the passage 632. The cavity 630 and the passage 632. The second passage 442 may be in fluid communication with and be connect via surfaces to the cavity 630. The volume 242 of FIG. 2 may comprise the second passage 442, the cavity 630, and the passage 632.

The bracket 330 includes a cutout 642. The cutout 642 is a volume taken from the material of the main body 428. The cutout 642 may extend from one or more outer surfaces of the main body 428 to one or more inner surfaces of the inner land 448 and the second rim 449. The opening 438 may be open to an exterior of the main body 428 via the cutout 642. The cutout 642 may allow the second gear 334 to mesh with the first gear 332. The second gear 334 is arranged in part within the cutout 642, wherein a portion of the second gear 334 may be positioned within the volume of the cutout 642. The cutout 642 exposes at least one gear that may be covered by main body 428 to another gear that drivingly couples to a lay shaft. For example, the cutout 642 exposes the first gear 332 to the second gear 334, respectively. The cutout 642 extends to the opening 438 through the main body 428, creating a gap through the second rim 449 and a portion of the inner land 448.

The fourth view 600 shows a shaft component 652 may comprise or be joined to the third gear 336. Said in another way, a unitary rotational component may comprise the shaft component 652 and the third gear 336. The shaft component 652 may be centered about the second axis 206, such as to be radially around the second axis 206. The shaft component 652 may be the lay shaft of the gear train 314. The second gear 334 may be rigidly coupled to the shaft component 652. The shaft component 652 may be the second shaft of FIG. 2. The shaft component 652 may be fit to and received by a passage 654 of the second gear 334, referred to herein as the sixth passage 654. The sixth passage 654 may be concentric to the second gear 334 and centered around the second axis 206. The shaft component 652 may couple to the second gear 334 via the sixth passage 654. The fifth passage 550 may be concentric to the shaft component 652, and the fifth passage 550 may be a through-passage, such as a through-hole, extending between and open to opposite sides of the shaft component 652.

A cap 656 may be fit to and received by the fourth passage 452. The cap 656 may separate the fourth passage into a first section 658 and a second section 659. The first section 658 is opposite to the second section 659 from the cap 656. The cap 656 may prevent fluid from entering the first section 658 via the second section 659.

A fifth bearing assembly 660 may be positioned radially about and support the second gear 334. The fifth bearing assembly 660 may be the third bearing assembly 260.

A flow path of a fluid is shown schematically. The flow path may be represented by a plurality of dotted arrows 672. The fluid flowed by the flow path may be lubricant or lubricant/coolant that may cool and lubricate the rotor assembly 526 and gear train 314. A method is described for the flow path from upstream to downstream through rotor assembly 526 and the gear train 314, herein. The flow path may begin upstream of the passage 632, flowing fluid into the rotor assembly 526 via passage 632 and the cavity 630. Fluid may flow out of the rotor assembly 526 and through the output 340 via the second passage 442. Fluid may flow to gear train 314 via the second passage 442. Fluid may flow to the fourth passage 452 via the second section 659. The cap 656 may divert fluid to flow out of the fourth passage 452 and to the opening 438. From the opening 438, the fluid may flow to lubricate the first gear 332 and the second gear 334, such as at the mesh between the first gear 332 and second gear 334. Fluid may also flow from the opening 438 to lubricate the fourth bearing assembly 456. Fluid may flow further outward to lubricate the third gear 336 and the fourth gear 338. Fluid may also be splashed and carried via the first gear 332, the second gear 334, third gear 336, fourth gear 338, and their respective teeth.

Turning to FIG. 7, it shows a fifth view 700 of the bracket 330. The fifth view 700 is a side view of the bracket 330, where the bracket 330 is separated from the other components of the gear train 314.

The bracket 330 has a first side 702 and a second side 704. The first side 702 may be positioned nearest to the cover 320 and fourth gear 338 of FIG. 3 compared to the second side 704. The first side 702 may be received and covered by the cavity 450 of FIG. 4. The second side 704 may be positioned nearest to the electric machine 312 of FIG. 3, the platform 422, and the third bearing assembly 454 of FIG. 4, and nearest to the body 540 of FIG. 5, compared to the first side 702. The fifth view 700 also shows a plurality of directions represented schematically via arrows including a first direction 706, a second direction 708, a third direction 712, and a fourth direction 714. The first direction 706 and the second direction 708 are parallel with the first axis 204. The first direction 706 is opposite the second direction 708. The first direction 706 and the second direction 708 are normal to and extend outward from the first side 702 and the second side 704, respectively. The third direction 712 and fourth direction 714 are lateral with respect the first axis 204 and may be parallel with the x-axis of the reference axes 301. The third direction 712 is opposite the fourth direction 714.

The fifth view 700 shows, the first side 702 of the first protrusion 430, the second protrusion 434a, and the third protrusion 434b. The first protrusion 430 may extend outward from main body 428 in an approximately radial direction. The second and third protrusions 434a, 434b extend outward from the main body 428 in a direction between tangential and radial, where the direction may change between more radial and more tangential. The cutout 642 may be positioned between two neighboring protrusions of the bracket 330. The neighboring protrusions may be neighboring arms. For example, the cutout 642 may be between the second protrusion 434a and the third protrusion 434b. It is to be appreciated, that the second protrusion 434a and the third protrusion 434b may be symmetrical and mirrored at opposite sides of the cutout 642.

The main body 428 comprises a plurality of surfaces, including a first surface 718 and a second surface 720 that are outer surfaces, and a third surface 722, a fourth surface 724, a fifth surface 726, and a sixth surface 728 that are inner surfaces. The first surface 718 is partially cylindrical in shape, curving radially about the first axis 204. The first surface 718 is contiguous with the second surface 720. The second surface 720 is on the first side 702 and has an area normal to the first axis 204. The second surface 720 is circular and ring-like in shape. The second surface 720 is contiguous with the third surface 722. The third surface 722 may be an inner surface of the first rim 444 of FIG. 4. The third surface 722 is cylindrical in shape and curves radially around the first axis 204. The third surface 722 is contiguous with the fourth surface 724 via the shoulder 446. The shoulder 446 may have an area normal to the axis, and may be circular and ring-like in shape. The fourth surface 724 is connected to the fifth surface 726 via the sixth surface 728. Both the fourth surface 724 and fifth surface 726 are contiguous with the sixth surface 728. The fifth surface 726 and sixth surface 728 may be surfaces of the second rim 449 of FIG. 4. The fourth surface 724 is an inner surface of the inner land 448 of FIG. 4. The fourth surface 724 and the fifth surface 726 are partially cylindrical in shape and curve radially around the first axis 204. The sixth surface 728 is partially frustoconical in shape and curves radially around the first axis 204. The cutout 642 extends radially inward from the first surface 718 to the fourth surface 724, the fifth surface 726, and the sixth surface 728.

The cutout 642 shapes a seventh surface 727 and an eighth surface 729 from the main body 428. The seventh surface 727 and the eighth surface 729 may be at opposite sides of the cutout 642. The seventh surface 727 and eighth surface 729 are compound shapes that each comprise rectangular shaped areas. The seventh surface 727 and eighth surface 729 are contiguous with the fourth surface 724, the fifth surface 726, and the sixth surface 728. The seventh surface 727 may be nearest to and contiguous with the second protrusion 434a. The eighth surface 729 may be nearest to and contiguous with the third protrusion 434b. It is to be appreciated, that the seventh surface 727 and the eighth surface 729 may be symmetrical and mirrored at opposite sides of the cutout 642.

The first protrusion 430 may be a compound shape comprised of a plurality of shapes both regular and irregular. The first protrusion 430 is rounded. For example, the first protrusion 430 has a side facing the third direction 712 and an opposite side facing the fourth direction 714 that are rounded. As an arm, the first protrusion 430 comprises a first beam that extends outward from the main body 428 to the first distal end 431. The first protrusion 430 and the first beam extends in a radial direction from main body 428. The first beam has rounded edges and is defined in shape by flat surfaces and rounded surfaces, the rounded surfaces face the third and fourth directions 712, 714. For example, the first protrusion 430 includes a ninth surface 730, a tenth surface 732, and an eleventh surface 734. The ninth surface 730, the tenth surface 732, and the eleventh surface 734 defines the shape of the first beam. A curved surface defines the shape of the first distal end 431 of the first protrusion 430. The ninth surface 730 is part of the first side 702 of the bracket, and the ninth surface 730 is approximately flat and normal to the first axis 204. The tenth surface 732 and the eleventh surface 734 may be a first rounded surface and a second rounded surface, respectively, for the first protrusion 430. The tenth surface 732 and the eleventh surface 734 may be continuous with and connected to the ninth surface 730. The tenth surface 732 may be opposite the eleventh surface 734 across and with respect to the ninth surface 730. The tenth surface 732 and the eleventh surface 734 may curve about the first protrusion 430, such that the first protrusion 430 is rounded. The tenth surface 732 and eleventh surface 734 may be contiguous with and connected to a surface of the first protrusion 430 opposite the ninth surface 730. The ninth surface 730 may be an irregular shape. A first recess 742 of the first protrusion 430 shapes a curved depression from the ninth surface 730. The first mount 432 may be connected or physically coupled to the first recess 742. The first mount 432 may be raised outward from the first recess 742, such as in the first direction 706 from the first recess 742.

The second protrusion 434a may be a compound shape comprised of a plurality of shapes both regular and irregular. For example, the second protrusion 434a may have rounded edges and may curve outwardly in the fourth direction 714. As an arm, the second protrusion 434a may include a second beam. The second beam has rounded edges and is defined in shape by both flat surfaces and rounded surfaces. The second protrusion 434a curves toward the third direction 712 and downward with respect to the z-axis of the reference axes 301.

The second protrusion 434a includes a twelfth surface 736a, a thirteenth surface 738a, a fourteenth surface 740a, and an eighteenth surface 741a. The twelfth surface 736a, the thirteenth surface 738a, and the fourteenth surface 740a may define the shape of the second beam. The twelfth surface 736a is part of the first side 702 of the bracket and is approximately flat and normal to the first axis 204. The thirteenth surface 738a and the fourteenth surface 740a may be rounded surfaces continuous with and connected to the twelfth surface 736a. The thirteenth surface 738a may be a first rounded surface and fourteenth surface 740a may be a second rounded surface for the second protrusion 434a. The thirteenth surface 738a may be opposite the fourteenth surface 740a across and with respect to the twelfth surface 736a. The thirteenth surface 738a may curve with a curvature of the first radius 772. The fourteenth surface 740a may extend approximately tangentially from the main body 428. The thirteenth surface 738a and the fourteenth surface 740a may curve about the second protrusion 434a, and connect to a surface of the second protrusion 434a part of the second side 704. The thirteenth surface 738a may curve outward and downward from the seventh surface 727 to the eighteenth surface 741a. The fourteenth surface 740a may curve outward and downward from the first surface 718 to the eighteenth surface 741a. The thirteenth surface 738a and the fourteenth surface 740a may be connected to and continuous with the eighteenth surface 741a. The eighteenth surface 741a may curve around the second distal end 435a of the second protrusion 434a. The eighteenth surface 741a may curve in elliptical way, such as in a circular way, giving the second distal end 435a a partially cylindrical shape.

The twelfth surface 736a may be an irregular shape. A second recess 744 of the first protrusion 430 shapes a curved depression from the twelfth surface 736a. The second mount 436a may be connected or physically coupled to the second recess 744. The second mount 436a may be raised outward from the second recess 744, such as in the first direction 706 from the second recess 744. The eighteenth surface 741a may be connected to and contiguous with the second recess 744.

The third protrusion 434b may be a compound shape comprised of a plurality of shapes both regular and irregular. For example, the third protrusion 434b have rounded edges and may curve outwardly in the fourth direction 714. As an arm, the third protrusion 434b may comprise a third beam. The third beam is defined in shape by flat surfaces and rounded surfaces. For example, the third protrusion 434b has a side facing the third direction 712 and an opposite side facing the fourth direction 714 that are rounded.

The third protrusion 434b includes a fifteenth surface 736b, a sixteenth surface 738b, a seventeenth surface 740b, and a nineteenth surface 741b. The fifteenth surface 736b, the sixteenth surface 738b, the seventeenth surface 740b define the shape of the beam. The fifteenth surface 736b is part of the first side 702 of the bracket and is approximately flat and normal to the first axis 204. The sixteenth surface 738b and the seventeenth surface 740b may be rounded surfaces continuous with and connected to the fifteenth surface 736b. The sixteenth surface 738b may be a first rounded surface and seventeenth surface 740b may be a second rounded surface for the third protrusion 434b. The sixteenth surface 738b may be opposite the seventeenth surface 740b across and with respect to the fifteenth surface 736b. The sixteenth surface 738b may curve with a curvature of the second radius 774. The seventeenth surface 740b may extend approximately tangentially from the main body 428. The sixteenth surface 738b and the seventeenth surface 740b may curve about the third protrusion 434b, and be connected to a surface of the third protrusion 434b part of the second side 704. The sixteenth surface 738b may curve outward and upward from the eighth surface 729 to the nineteenth surface 741b. The seventeenth surface 740b may curve outward and upward from the first surface 718 to the nineteenth surface 741b. The sixteenth surface 738b and the seventeenth surface 740b may be connected to and continuous with the nineteenth surface 741b. The nineteenth surface 741b may curve around the third distal end 435b of the third protrusion 434b. The nineteenth surface 741b may be a partially elliptical shape, such as a partial ring, giving the third distal end 435b a partially cylindrical shape.

The fifteenth surface 736b may be an irregular shape. A third recess 746 of the third protrusion 434b shapes a curved depression from the fifteenth surface 736b. The third mount 436b may be connected or physically coupled to the third recess 746. The third mount 436b may be raised outward from the third recess 746, such as in the first direction 706 from the third recess 746. The nineteenth surface 741b may be connected to and contiguous with the third recess 746.

The fifth view 700 shows that the bracket 330 may include a first fit 750 and a second fit 552a in addition to the fit 552b. The first fit 750 is complementary to the first protrusion 430, where the first protrusion 430 and the first mount 432 may comprise the first fit 750. Likewise, the second fit 552a is complementary to the second protrusion 434a, where the second protrusion 434a and the second mount 436a may comprise the second fit 552a. The fit 552b may be referred to herein as the third fit 552b. The first fit 750 and the second fit 552a may be through-holes. The first mount 432 may be a first boss, with a surface 752 that extends radially from the first fit 750. The second mount 436a may be a second boss with a surface 754 that extends radially from the second fit 552a. The third mount 436b may be a second boss may include a surface 756 that extends radially from the third fit 552b. The surface 752, the surface 754, and the surface 756 may have circular or partially circular edges and be normal to the first axis 204.

The bracket 330 may include a first slope 758 connecting the first surface 718 to the twelfth surface 736a. Likewise, the bracket 330 may include a second slope 760 connecting the first surface 718 to the thirteenth surface 738a. The first slope 758 and the second slope 760 may depress longitudinally with toward the second side 704 from the first surface 718. The main body 428 includes a first rounded edge 762 and a second rounded edge 764. The first rounded edge 762 connects the first surface 718 to the second surface 720, where the first surface 718 and the second surface 720 are each continuous with the first rounded edge 762. Likewise, the second rounded edge 764 may connect the first surface 718 to one or more surfaces of the second side 704, such as one or more surfaces of the cutout 642. The second rounded edge 764 is continuous with the first surface 718. The second protrusion 434a includes a third rounded edge 766 connects the twelfth surface 736a to the thirteenth surface 738a. The third rounded edge 766 may extend outward toward and curve around the second distal end 435a of the second protrusion 434a. The third protrusion 434b includes a fourth rounded edge 768 connects to the fifteenth surface 736b to the sixteenth surface 738b. The fourth rounded edge 768 may extend outward toward and curve around the third distal end 435b of the third protrusion 434b.

The first protrusion 430 may be a first width 780. The second protrusion 434a may be a second width 782. The third protrusion 434b may be a third width 784. The first width 780, second width 782, and third width 784 may be variable, changing in an outward direction from the main body 428. For example, the first protrusion 430 tapers, such that the first width 780 decreases closer to the first distal end 431. The second protrusion 434a tapers, such that the second width 782 decreases closer to the second distal end 435a. The third protrusion 434b tapers, such that the third width 784 decreases closer to the third distal end 435b. The second width 782 may be greatest at the first slope 758. The third width 784 may be greatest at the second slope 760. The first width 780 may decrease to an infinitesimally small distance at the first distal end 431 of FIG. 4. The second width 782 and the third width 784 may decrease to infinitesimally small distances at the second distal end 435a and the third distal end 435b, respectively. The second width 782 and the third width 784 may decrease to infinitesimally small distances at the curve of the eighteenth surface 741a and the curve of the nineteenth surface 741b, respectively. It is to be appreciated, that the curved surface of the first distal end 431 is partially elliptical in curvature and may be partially circular. The curved surface may give the first distal end 431 may be partially cylindrical shape. The curved surface may be approximately symmetrical with the eighteenth surface 741a and the nineteenth surface 741b.

It is to be appreciated, that the bracket 330 may have additional protrusions from the first protrusion 430, the second protrusion 434a, and the third protrusion 434b, such as a fourth protrusion. It is to be appreciated, that the bracket 330 may have additional mounts from the first mount 432, the second mount 436a, and the third mount 436b, such as a fourth mount.

The second protrusion 434a may extend at a first angle 776 from the main body 428. The second protrusion 434a may curve while extending outward, where the curvature is of a first radius 772. The second protrusion 434a may extend at a second angle 778 outward from the curvature. The curvature of the first radius 772 may cause the second protrusion 434a to gradually angle and extend in a more tangential direction from a more radial direction further outward from the main body 428 and closer to the second distal end 435a. The second protrusion 434a extends more radially from the first angle 776 and more tangentially from the second angle 778 relative to the main body 428.

Likewise, the third protrusion 434b may extend at a third angle 786 from the main body 428. The third protrusion 434b may curve while extending outward, where the curvature is of a second radius 774. The third protrusion 434b may extend at a fourth angle 788 outward from the curvature. The curvature of the second radius 774 may cause the third protrusion 434b to gradually angle and extend in a more tangential direction from a more radial direction further outward from the main body 428 and closer to the third distal end 435b. The third protrusion 434b extends more radially from the third angle 786 and more tangentially from the fourth angle 788 relative to the main body 428.

Turning to FIG. 8, it shows a sixth view 800 of the gear train 314 and the rotor assembly 526. The sixth view 800 is a side view, where the view plane is normal to the y-axis of the reference axes 301, the first axis 204 and the second axis 206.

The sixth view 800 shows a first fastener 842, a second fastener 844, and a third fastener 846 that are complementary to be received by and extended through the bracket 330. The first fastener 842, the second fastener 844, and the third fastener 846 may fasten the bracket 330 to a complementary structure that the fasteners 842, 844, 846 may be received by an extend through. The fasteners 842, 844, 846 may fasten the bracket 330 to the second housing 318 and more specifically the platform 422 of FIGS. 3-4. The first fastener 842 may be received and extended through the first mount 432, via the first fit 750. The second fastener 844 may be received by and extended through second mount 436a via the second fit 552a. The third fastener 846 may be received by and extend through the third mount 436b via the third fit 552b. The first fastener 842, the second fastener 844, and the third fastener 846 include fastener heads and may be bolts. A first head of the first fastener 842 may abut and press against the surface 752, such as when received by the first mount 432. A second head of the second fastener 844 may abut and press against the surface 754, such as when received by the second mount 436a. A third head of the second fastener 844 may abut and press against the surface 756, such as when received by the third mount 436b. The first fastener 842, the second fastener 844, and the third fastener 846 may be symmetrical.

The bracket 330 may be a first diameter 852 extending between opposite sides of a circle 856, referred to herein as the bracket diameter 852. The bracket diameter 852 and circle 856 may be within the mounts of the bracket 330, including the first mount 432, the second mount 436a, and the third mount 436b. Said in another way, the mounts of the bracket 330, including the first mount 432, the second mount 436a, and the third mount 436b, may touch or be outside of the bracket diameter 852 and the circle 856. The bracket diameter 852 is greater in distance than a second diameter 854 of the fourth gear 338, referred to herein as the output gear diameter 854. The output gear diameter 854 is a maximum outer diameter for the fourth gear 338, where the output gear diameter 854 includes the actual tooth thickness of the fourth teeth 578. Said in another way, the output gear diameter 854 extends across another circle that touches the outer most tips of the fourth teeth 578. The mounts and their respective distal ends of the bracket 330 may be arranged outward from and outside of the output gear diameter 854, such as when the bracket 330 and output gear diameter 854 are co-axial. The arrangement of the mounts of the bracket 330, such as the first mount 432, the second mount 436a, and the third mount 436b, outside of the output gear diameter 854 may allow the gear train 314 and the bracket 330 to be physically coupled to housing as a unit. For example, the bracket 330 may be fastened to the housing via a plurality of fasteners that are complementary, such as to be received by the first mount 432, the second mount 436a, and the third mount 436b. Complementary fasteners to the bracket 330 may include the first fastener 842, the second fastener 844, and the third fastener 846. The fasteners may extend through the first mount 432, the second mount 436a, the third mount 436b and be received by and fasten to fits, such as holes, of the second housing 318. The fits of the second housing 318 may have fastening feature, such as a threading, that may mesh with the complementary fasteners of the bracket 330. Fastening the fasteners to fits of the housing may fasten the bracket 330 to the housing. The arrangement of the mounts of the bracket 330 outside of the output gear diameter 854, may allow fasteners complementary to the mounts, such as the first fastener 842, the second fastener 844, and the third fastener 846, to be received by and removed from the first mount 432, the second mount 436a, and the third mount 436b without removing the fourth gear 338 or other rotational elements from the gear train 314. The gear train 314 and bracket 330 may therein be removable from the second housing 318 as a unit via removal of the fasteners 842, 844, 846 from the bracket 330.

The arrangement of the of the mounts and distal ends of the bracket 330 and their complementary distal ends may allow the gear train 314 to be removed from the housing without disassembly, with exception to removing the fasteners of the bracket 330, such as the first fastener 842, second fastener 844, and the third fastener 846. The fourth gear 338 may be the gear with the largest diameter, (e.g., the largest gear), of the gears of the gear train 314 co-axial with bracket 330. For other examples, the bracket diameter 852 may be larger than the diameter of the largest gear of gears that are co-axial sharing a common axis with the bracket 330 of the gear train 314.

Turning to FIG. 9, it shows a seventh view 900 of the assembly 302. The seventh view 900 is a sectional view, showing the assembly 302 sectioned by a view plane parallel to a plane formed by the y-axis and z-axis of the reference axes 301. The seventh view 900 is taken on a view plane perpendicular to the second view 400 of FIG. 4.

The seventh view 900 shows, the fifth bearing assembly 660 may be fit to the mounted carrier 364. The mounted carrier 364 may curve radially about the fifth bearing assembly 660. The second gear 334 may be centered around second axis 206 via the mounted carrier 364, such as when the second gear 334 is received by the fifth bearing assembly 660 and the bearing assembly is received and fit to the mounted carrier 364. Likewise, the mounted carrier 364 supports the second gear 334 and the third gear 336, such that the second gear 334 and third gear 336 may be co-axial and centered around the second axis 206.

The seventh view 900 shows a stator 940 and plurality of windings 942 that may carry a current and generate electromagnetic forces to drive the electric machine 312. Electromagnetic forces of the windings 942 may drive the rotor assembly 526 to spin radially around first axis 204, generating a torque and power flow to be transferred to the gear train 314. The stator 940 and rotor assembly 526 may be housed and enclosed by the first housing 316 and the second housing 318. The stator 940 may be positioned about the rotor assembly 526, such as around the rotor assembly 526. A portion of the windings 942 may be housed by the second housing 318, and the portion of the windings 942 may be covered and separated from the gear train 314 via the platform 422. A portion of the windings 942 may be housed and extend through the stator 940, such as via a plurality of passages and cavities arranged radially throughout the stator 940.

In this way, the disclosed system provides a system including a bracket that may fasten to a housing of an electric machine assembly and support an output gear to a gear train, such that the input gear is co-axial with an output gear and/or an output shaft of the gear train. The gear train is of a lay shaft configuration. An input gear to the gear train and the output gear are not rigidly coupled, such as when meshed with the gear train and supported via the bracket. The bracket includes a main body and a plurality of protrusions, where the plurality protrusions comprise a plurality of mounts. The protrusions may be arms. The main body includes a void, such as a cutout, that extends from the outer surfaces to the inner surfaces of the cutout. The main body also includes an opening. The main body may be positioned about the input gear, such that the input gear is received by the opening. Likewise, a bearing that may support the output gear may be housed and supported by the main body, where the bearing is received by the opening. And the input gear may mesh with the first gear via the cutout. The plurality of protrusions extends outward from the annular section. The mounts may receive fasteners and fasten to the housing. Each of the mounts are connected to at least a protrusion of the protrusions. The mounts are arranged at least at circle with a first diameter. The output gear may be of a second diameter, where the second diameter is less than the first diameter. Mounts may therein be positioned outside the second diameter. The mounts may physically couple to or in part comprise the distal ends of the protrusions.

The disclosure also provides support for a system including an electric motor comprising an electric motor output shaft, a gear train comprising an input gear coupled to a first gear arranged on a lay shaft, further comprising a second gear arranged on the lay shaft and coupled to an output gear, wherein the input gear is further coupled to the electric motor output shaft and the output gear is coupled to a gear train output shaft, and a support is physically coupled to a housing of the electric motor, wherein the support is configured to support a first bearing coupled to the input gear and a second bearing coupled to the output gear. In a first example of the system, the support comprises a plurality of protrusions that extend to a location radially outside of the output gear. In a second example of the system, optionally including the first example, each of the plurality of protrusions comprises a through-hole for receiving a fastener configured to engage with the housing of the electric motor. In a third example of the system, optionally including one or both of the first and second examples, the support comprises a cutout, and wherein the input gear and the first gear mesh at the cutout. In a fourth example of the system, optionally including one or more or each of the first through third examples, the electric motor output shaft and the gear train output shaft are co-axial and configured to rotate about a same axis. In a fifth example of the system, optionally including one or more or each of the first through fourth examples, the lay shaft is parallel to the electric motor output shaft and the gear train output shaft. In a sixth example of the system, optionally including one or more or each of the first through fifth examples, the support and the gear train are arranged within a gear train housing. In a seventh example of the system, optionally including one or more or each of the first through sixth examples, the gear train housing is physically coupled to the housing of the electric motor. In an eighth example of the system, optionally including one or more or each of the first through seventh examples, the electric motor output shaft is spaced away from the gear train output shaft.

The disclosure also provides support for a system including a support comprising a main body from which a plurality of arms extends outward from the main body relative to a central axis of the support, wherein the main body further comprises an opening configured to couple to an input gear bearing and an output gear bearing of a gear train. In a first example of the system, the main body comprises a cutout between neighboring arms of the support. In a second example of the system, optionally including the first example, the plurality of arms extends to a position radially outside of an output gear. In a third example of the system, optionally including one or both of the first and second examples, the support is physically coupled to a housing of a prime mover via fasteners extending through through-holes of the plurality of arms. In a fourth example of the system, optionally including one or more or each of the first through third examples, the plurality of arms extends at an angle from the main body in a direction away from a rotational axis of a mover. In a fifth example of the system, optionally including one or more or each of the first through fourth examples, the opening comprises a plurality of diameters.

The disclosure also provides support for a system including a support arranged in a gear train housing and physically coupled to an electric motor housing, wherein the support comprises an opening in face-sharing contact with an input gear bearing and an output gear bearing. In a first example of the system, the support comprises a plurality of arms extending from the opening to a location radially outside of an output gear, and wherein the plurality of arms comprises through-holes configured to receive a plurality of fasteners. In a second example of the system, optionally including the first example, the support comprises a cutout adjacent to an input gear, wherein a gear of a lay shaft engages with the input gear at the cutout. In a third example of the system, optionally including one or both of the first and second examples, the support is a single piece. In a fourth example of the system, optionally including one or more or each of the first through third examples, the support extends from the electric motor housing, across an entirety of a portion of an electric motor output shaft extending into the gear train housing, and to a portion of a gear train output shaft.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
an electric motor comprising an electric motor output shaft;
a gear train comprising an input gear coupled to a first gear arranged on a lay shaft, further comprising a second gear arranged on the lay shaft and coupled to an output gear, wherein the input gear is further coupled to the electric motor output shaft and the output gear is coupled to a gear train output shaft; and
a support physically coupled to a housing of the electric motor, wherein the support is configured to support a bearing coupled to the output gear.

2. The system of claim 1, wherein the support comprises a plurality of protrusions that extend to a location radially outside of the output gear.

3. The system of claim 2, wherein each of the plurality of protrusions comprises a through-hole for receiving a fastener configured to engage with the housing of the electric motor.

4. The system of claim 1, wherein the support comprises a cutout, and wherein the input gear and the first gear mesh at the cutout.

5. The system of claim 1, wherein the electric motor output shaft and the gear train output shaft are co-axial and configured to rotate about a same axis.

6. The system of claim 1, wherein the lay shaft is parallel to the electric motor output shaft and the gear train output shaft.

7. The system of claim 1, wherein the support and the gear train are arranged within a gear train housing.

8. The system of claim 7, wherein the gear train housing is physically coupled to the housing of the electric motor.

9. The system of claim 1, wherein the electric motor output shaft is spaced away from the gear train output shaft.

10. A system, comprising:
a support comprising a main body from which a plurality of arms extends outward from the main body relative to a central axis of the support, wherein the main body further comprises an opening configured to couple to an output gear bearing of a gear train.

11. The system of claim 10, wherein the main body comprises a cutout between neighboring arms of the support.

12. The system of claim 10, wherein the plurality of arms extends to a position radially outside of an output gear.

13. The system of claim 10, wherein the support is physically coupled to a housing of a prime mover via fasteners extending through through-holes of the plurality of arms.

14. The system of claim 10, wherein the plurality of arms extends at an angle from the main body in a direction away from a rotational axis of a mover.

15. The system of claim 10, wherein the opening comprises a plurality of diameters.

16. A system, comprising:
a support arranged in a gear train housing and physically coupled to an electric motor housing, wherein the support comprises an opening in face-sharing contact with an output gear bearing.

17. The system of claim 16, wherein the support comprises a plurality of arms extending from the opening to a location radially outside of an output gear, and wherein the plurality of arms comprises through-holes configured to receive a plurality of fasteners.

18. The system of claim 16, wherein the support comprises a cutout adjacent to an input gear, wherein a gear of a lay shaft engages with the input gear at the cutout.

19. The system of claim 16, wherein the support is a single piece.

20. The system of claim 16, wherein the support extends from the electric motor housing, across an entirety of a portion of an electric motor output shaft extending into the gear train housing, and to a portion of a gear train output shaft.
